(19) United States
(12) Patent Application Publication
(10) Pub. No.: US 2007/0176976 A1
(43) Pub. Date: Aug. 2, 2007

(54) PRINT HEAD

(75) Inventor: YUKI FUJIWARA, Beppu-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Joso-shi (JP)

(21) Appl. No.: 11/668,199

(22) Filed: Jan. 29, 2007

(30) Foreign Application Priority Data
Feb. 2, 2006 (JP) 2006-026349

(51) Int. Cl. B41J 2/05

(52) U.S. Cl. 347/65

(57) ABSTRACT

It is an object of this invention to provide a print head which can stably eject ink droplets of large volume without being influenced by negative pressure variations in an ink supply source or by drive conditions. To this end the ink jet print head of this invention includes a plurality of nozzle openings to eject ink, a plurality of liquid paths communicating with these nozzle openings, and energy generation portion to eject ink supplied to each liquid path from each nozzle opening in the form of an ink droplet. In a part of each liquid path, a dividing portion to divide the liquid path into a plurality of paths is installed inward of the nozzle opening.

This application claims the benefit of Japanese Patent Application No. 2006-026349, filed Feb. 2, 2006, which is hereby incorporated by reference herein in its entirety.

### BACKGROUND OF THE INVENTION

1. Field of the Invention

The present invention relates to an ink jet print head having a plurality of nozzles and adapted to eject ink droplets from its nozzles, and more particularly to a print head that ejects ink droplets of relatively large volume.

2. Description of the Related Art

Ink jet printing apparatus perform printing by ejecting ink droplets from nozzles arrayed in their print head to directly land on a print medium. This allows the printing operation to be performed with low noise and obviates the need for special processing such as development. The ink jet printing apparatus therefore have advantages of being able to be constructed at low cost and in small size and to realize a color printing capability easily. Particularly with an ink jet printing apparatus that uses heat as an energy to eject ink droplets, a plurality of nozzles in the print head can be formed at high density, which in turn makes it possible to print an image of high resolution and quality at high speed.

FIG. 14 shows an example of such an ink jet printing apparatus. Denoted 115(K), 115(C), 115(M) and 115(Y) are full-line type print heads extending in a direction perpendicular to a plane of the sheet of FIG. 14. A maximum print width of these print heads is larger than the width of a print medium P used. From these print heads 115(K), 115(C), 115(M), 115(Y), black, cyan, magenta and yellow inks are ejected toward the print medium P at predetermined timings. This is followed by the print medium P being transported in a direction of arrow shown in FIG. 14, thus forming a color image on the print medium P. The print medium P shown in FIG. 14 is a rolled, continuous label sheet. The label sheet P supplied from a roll supply unit 117 is fed at a preset speed by a transport unit 118 installed below the print head 115.

Ink cartridges 119(K), 119(C), 119(M), 119(Y) and the print heads 115(K), 115(C), 115(M), 115(Y) are connected for each ink color to an ink supply system not shown. A recovery tub 120 to collect ink discharged from the nozzles of the print head 115 as by a cleaning operation is also connected to the ink supply system for each ink color.

A structure of a nozzle opening in a conventional print head of the above ink jet printing apparatus is shown in a schematic perspective view of FIG. 10. FIG. 11A is a longitudinally sectioned side view of the conventional print head showing the structure of nozzle openings and liquid paths communicating to them. FIG. 11B is a cross section taken along the line B-B of FIG. 11A. FIG. 11C is a front view of FIG. 11A.

A print head H1 shown in FIG. 10 and FIG. 11A to 11C has heater board 2, a plurality of nozzle sidewalls 6 erected at predetermined intervals on the heater board 2 and a top plate 7 put on upper surfaces of the nozzle sidewalls 6. These in combination form a plurality of nozzles 5, each comprising a nozzle opening 3, from which ink is ejected, and a liquid path 4 communicating with the nozzle opening. The heater board 2 forming one surface of each liquid path is provided with heaters 1 each of which generates an ejection energy to eject from the nozzle opening 3 the ink supplied to the associated liquid path 4.

In the print head of the above construction, when the heater 1 is energized, the ink supplied to the liquid path 4 is instantly heated by the heater 1 to produce a bubble in it. The pressure of the inflating bubble causes an ink droplet to be ejected from the nozzle opening 3.

The ink jet printing apparatus, particularly those for industrial use, print on various kind of print mediums. So, there is a growing trend that the ink jet printing apparatus are required to be able to use various kinds of special inks with characteristics that allow for their application to these print mediums. Among the special inks there are ones that have higher viscosities than those of ordinary inks and are difficult to eject stably. To stabilize the ejection of these special inks, the industrial ink jet printing apparatus increase the volume or size of ink droplets ejected.

This, however, requires increasing an opening area of each nozzle opening 3 in the print head H1. An increase in the area of the nozzle opening 3 results in a reduction in a force holding a meniscus in the print head H1 (meniscus force or capillary attraction force). This in turn makes the meniscus more likely to be broken when subjected to variations in a negative pressure in the ink supply system, giving rise to a problem that the ink may not be held in good condition in the nozzle 5. That is, if the meniscus is broken prior to an ejection operation, a situation arises where the heater is energized with no ink or only an insufficient amount of ink left in the nozzle 5, causing a faulty ejection of ink droplets.

Further, the small capillary attraction force in the nozzle 5 causes another problem. When the amount of ink in the ink tank, that supplies ink to the print head H1, decreases and the resultant negative pressure increases, an ink refilling to the nozzle becomes slow. As a result, the ink ejection becomes unstable, and a printed result gets hoarse.

The conventional print head H1, as described above, has two conflicting problems that an increase in the opening area of the nozzle opening 3 degrades a meniscus maintaining performance and a nozzle refilling performance and that, conversely, a reduction in the nozzle opening area makes it difficult to secure a sufficient volume of ink droplet to be ejected.

Under these circumstances, it has been proposed and practiced to use print heads H2 and H3 such as shown in FIG. 12 and FIG. 13. The print head H2 shown in FIG. 12 has a pair of square nozzle openings 3a, 3b of relatively small areas arranged close together. This construction causes ink droplets ejected from the nozzle openings 3a, 3b to merge together into a single droplet.

The print head H3 shown in FIG. 13 has a square nozzle opening of a large area divided by a partition wall into two rectangular nozzle openings 3c, 3d. This construction also causes ink droplets expelled from the nozzle openings 3c, 3d to merge together into a single droplet.

In the print heads H2, H3 shown in FIG. 12 and FIG. 13, the ink droplets are expelled, isolated from each other, from each of nozzle openings. So, these ink droplets do not merge together to form a single droplet and may degrade the quality of a printed image. Particularly, in the case of the print head of FIG. 13, the individual, separated nozzle openings are elongate rectangles in shape, making the direction in which the ink droplets are ejected from the nozzle openings unstable, with the result that the droplets hardly merge into a single droplet. In the print head shown in FIG. 12, ink is expelled from the square nozzle openings 3a, 3b. So, if the ink droplets expelled merge together, the united ink droplet as a whole is elongate, making the direction of the flying ink droplet unstable.

### SUMMARY OF THE INVENTION

The present invention has been accomplished with a view to overcoming the above-mentioned problems and it is an object of this invention to provide a print head capable of stably ejecting ink droplets of large volume without being influenced by negative pressure variations and drive conditions.

To achieve the above objective, the present invention has the following construction. The invention seeks to solve the above-mentioned problems by the following construction.

That is, viewed from a first aspect, this invention provides a print head comprising: a plurality of nozzle openings to eject ink; a plurality of liquid paths communicating with the nozzle openings: and a plurality of energy generation means to generate an ejection energy for ejecting the ink supplied to each liquid path from each nozzle opening in the form of droplet; wherein a dividing portion to divide a part of each liquid path into a plurality of paths is provided in an inward part of each liquid path.

With this invention, the provision of the dividing portion in the liquid path inward of the nozzle opening enhances a meniscus holding force, making it possible to properly eject ink as one droplet without splitting the ink droplet of large volume into smaller droplets. The provision of the dividing portion also enhances the ink refilling performance. As a result, ink droplets of large volume can be ejected stably without being affected by negative pressure variations and drive conditions.

Further features of the present invention will become apparent from the following description of exemplary embodiments (with reference to the attached drawings).

### BRIEF DESCRIPTION OF THE DRAWINGS

FIG. 1 is a perspective view schematically illustrating a construction of a nozzle opening and its associated components in a print head of this invention;

FIG. 2A is a longitudinally sectioned side view illustrating a construction of nozzle openings and liquid paths communicating with them in the print head;

FIG. 2B is a cross-sectional view taken along the line B-B of FIG. 2A;

FIG. 2C is a front view illustrating a construction of nozzle openings and liquid paths communicating with them in the print head;

FIG. 3A to FIG. 3E are conceptual diagrams illustrating an ink ejection process in the print head of FIG. 1 and FIG. 2A;

FIG. 4 is a cross-sectional view illustrating an example print head according to a second embodiment of this invention;

FIG. 5 is a cross-sectional view illustrating another example of the print head in the second embodiment of this invention;

FIG. 6A is a longitudinally sectioned side view schematically illustrating a construction of nozzle openings and liquid paths communicating with them in a print head according to a third embodiment of this invention;

FIG. 6B is a cross-sectional view taken along the line B-B of FIG. 6A;

FIG. 6C is a front view schematically illustrating a construction of nozzle openings and liquid paths communicating with them in the print head of the third embodiment of this invention;

FIG. 7A is a perspective view schematically illustrating how a movable valve is displaced as a bubble is formed in ink in the print head of FIG. 6A;

FIG. 7B is a longitudinally sectioned side view schematically illustrating how the movable valve is displaced as a bubble is formed in ink in the print head of FIG. 6A;

FIG. 8A is a conceptual diagram, as seen from the front, illustrating how the movable valve is displaced before and after a bubble is formed in ink in the print head of FIG. 6A, with the bubble yet to emerge;

FIG. 8B is a conceptual diagram, as seen from the front, illustrating how the movable valve is displaced before and after a bubble is formed in ink in the print head of FIG. 6A, with the bubble emerging;

FIG. 9 is a perspective view schematically illustrating a construction of a nozzle opening and its associated components in a print head of another embodiment of this invention;

FIG. 10 is a perspective view schematically illustrating a construction of a nozzle opening and its associated components in a conventional print head;

FIG. 11A is a longitudinally sectioned side view schematically illustrating a construction of nozzle openings and liquid paths communicating with them in the conventional print head;

FIG. 11B is a cross-sectional view taken along the line B-B of FIG. 1A;

FIG. 11C is a front view schematically illustrating a construction of nozzle openings and liquid paths communicating with them in the conventional print head;

FIG. 12 is a perspective view schematically illustrating a construction of nozzle openings and their associated components in the conventional print head with two square nozzle openings arranged side by side;

FIG. 13 is a perspective view schematically illustrating a construction of nozzle openings and their associated components in the conventional print head with its large square nozzle opening divided by a partition plate; and

FIG. 14 is a side view schematically illustrating an example of an ink jet printing apparatus.

### DESCRIPTION OF THE EMBODIMENTS

Now, embodiments of the present invention will be described in detail by referring to the accompanying drawings.

### First Embodiment

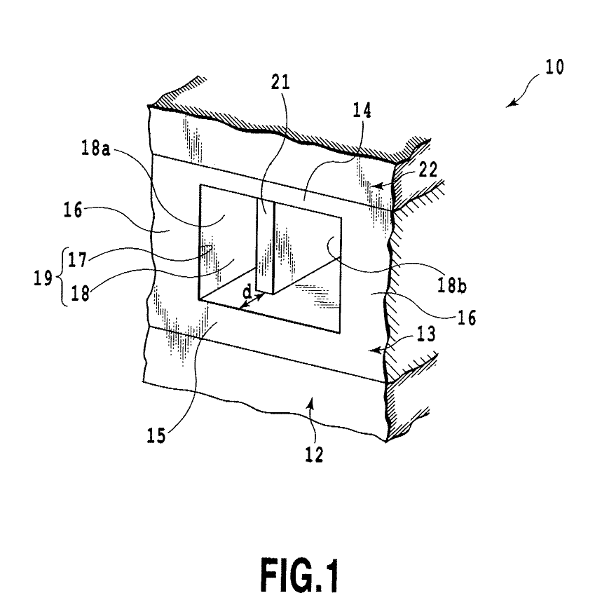

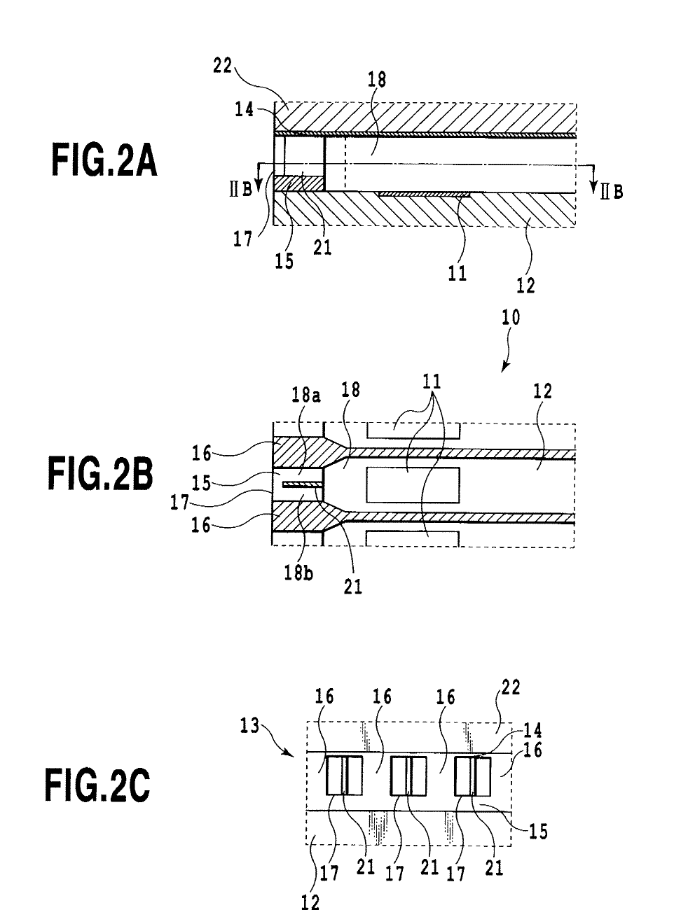

FIG. 1 is a perspective view schematically showing a construction of a nozzle opening and its associated components in a print head 10 according to a first embodiment of this invention used in an ink jet printing apparatus. FIG. 2A is a longitudinally sectioned side view showing a construction of nozzle openings and liquid paths communicating with them in the print head 10. FIG. 2B is a cross-sectional view taken along the line B-B of FIG. 2A. FIG. 2C is a front view of FIG. 2A.

As shown in FIG. 1 and FIGS. 2A to 2C, the print head 10 has a heater board 12 with heaters 11 to heat ink and form a bubble to expel an ink droplet, a nozzle forming member 13 installed on the heater board 12, and a top plate 22 placed on the nozzle forming member 13. End faces of these members are formed to lie in the same plane.

A nozzle opening forming surface, the end face of the nozzle forming member 13, is formed with ink ejecting, rectangular nozzle openings 17 at predetermined intervals and also with liquid paths 18 communicating with the nozzle openings 17. That is, the nozzle forming member 13 has a planar portion 14 adjoining the top plate 22 and forming one side of each nozzle opening 17 and a pair of sidewalls 16 arranged at predetermined intervals on the heater board 2 to form side surfaces of each nozzle opening 17. Further, the nozzle forming member 13 has a bottom portion 15 situated between the sidewalls 16 to form the remaining side of each nozzle opening 17. The nozzle forming member 13 also has formed at a position a predetermined distance d inward from the each nozzle opening 17 a platelike dividing portion 21 that divides a part of each liquid path 18. This dividing portion 21 is integrally formed of the same member of the planar portion 14 and the bottom portion 15.

As described above, the print head 10 in the first embodiment has a plurality of nozzle openings 17 formed in the nozzle forming member 13. The print head 10 also has a plurality of liquid paths 18 defined by the nozzle forming member 13 and the heater board 12 and communicating with the associated nozzle openings 17. The nozzle openings 17 and the liquid paths 18 combine to form nozzles 19. Each of the liquid paths 18 communicates with a common liquid chamber, not shown, provided in the print head 10. The common liquid chamber is supplied ink from an ink tank not shown, which is then supplied to individual liquid paths. During a printing operation an ink supply is done mainly by a capillary attraction of each liquid path. During a recovery operation of the print head 10, ink is supplied to the common liquid chamber by a pressure pump or suction pump not shown.

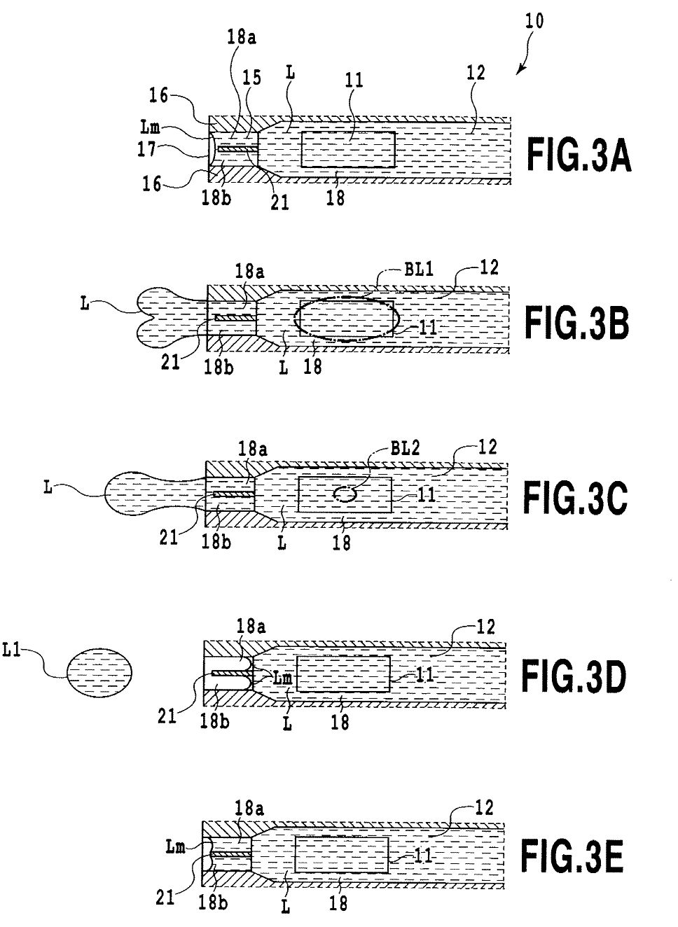

Next, a process of ink ejection from the print head of the above construction will be explained by referring to the conceptual diagrams of FIG. 3A to FIG. 3E.

FIG. 3A illustrates a normal meniscus Lm formed in the nozzle 19 of the print head. The meniscus Lm of ink L shown here is equal in an opening area of the nozzle opening 17 and is not in contact with the dividing portion 21.

FIG. 3B shows a bubble 11 being formed in the liquid path 18 as the heater 11 is energized. The liquid path 18 is divided in two by the dividing portion 21 extending from a position inside the liquid path to a position recessed a distance d inwardly from the nozzle opening 17. The ink that has flowed into the divided paths 18a, 18b separated by the dividing portion 21 is forced toward the nozzle opening 17. The front end of the ink, immediately after being ejected from the nozzle opening 17, is shaped like two droplets expelling parallel. However, since the inks that have passed through the two divided paths 18a, 18b are merged in a region of the nozzle where there is no dividing portion 21, ranging from the front end of the dividing portion 21 on the nozzle opening 17 side to the nozzle opening 17, the two ink droplets 12 combine into a single droplet in a bubble elimination phase, as shown in FIG. 3C. Therefore, the ink droplet ejected from one nozzle opening 17 flies as one droplet L1 without being split in two, as shown in FIG. 3D.

Then, after a part of the ink L has completely parted from the nozzle opening 17 as a flying ink droplet L1, the remaining ink L on the nozzle 19 side is retracted inwardly by a negative pressure in the liquid path 18, as shown in FIG. 3D. As a result, the meniscus of the ink L is formed in the divided paths 18a, 18b separated by the dividing portion 21. Since the cross-sectional areas of the divided paths 18a, 18b are separated by the dividing portion 21, the meniscus holding force (capillary attraction) is enhanced. The meniscus Lm that has retracted inwardly to the divided paths 18a, 18b therefore is not destroyed but maintained in these divided paths. Then, the meniscus in the divided paths 18a, 18b is displaced toward the front as the ink is refilled into the nozzle 19, as shown in FIG. 3E. In this refilling process, the divided paths 18a, 18b with small cross sections produce a large capillary force acting on the ink, quickly forcing the retracted meniscus Lm toward the nozzle opening 17 side. This in turn shortens the refilling time, assuring a stable ink ejection even in a high-speed printing operation.

With the first embodiment, as described above, a very stable ink ejection can be secured regardless of changes of the negative pressure of the ink tank and a wide range of drive conditions even when the meniscus holding force is enhancing while realizing the ejection of ink droplets of large volume.

### Second Embodiment

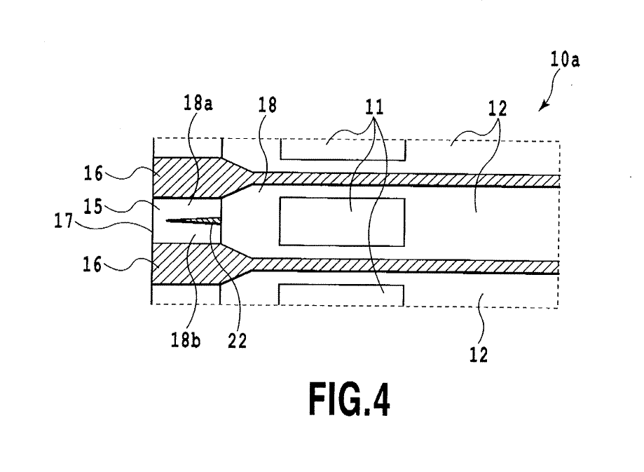

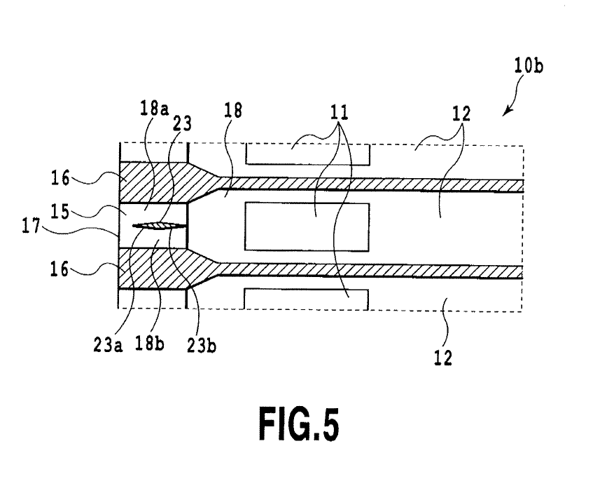

In the print head 10 shown in FIG. 1 to FIG. 3E, the dividing portion 21 is shaped like a flat plate of uniform thickness. The dividing portion 21, however, may be constructed in other shapes than that shown in FIG. 1 and FIGS. 3A to 3E. For example, it may be constructed in shapes of a second embodiment of this invention as shown in FIG. 4 or FIG. 5.

In a print head 10a shown in FIG. 4, there is provided a tapered dividing portion 22 whose thickness decreases toward the nozzle opening 17. The taper of the dividing portion allows the inks that have flowed through the two divided paths 18a, 18b separated by the dividing portion 22 to merge together easily as they are ejected from the nozzle opening 17, assuring a more stable ink ejection,

Further, like a dividing portion 23 in a print head 10b of FIG. 5, the dividing portion may also be provided with a tapered portion 23a that reduces its thickness toward the nozzle opening 17 and a tapered portion 23b that reduces its thickness toward the heater 11. This construction allows the inks that have flowed through the two divided paths 18a, 18b to merge together easily as they are ejected from the nozzle opening 17 and also makes an inflow of ink into the divided paths 18a, 18b at time of ink ejection and refilling more smooth. As a result, the inks that have passed through the divided paths 18a, 18b can merge more easily and the refilling of ink can be done more quickly. This embodiment therefore can also meet the demand for faster printing operation.

### Third Embodiment

Next, a third embodiment of this invention will be described.

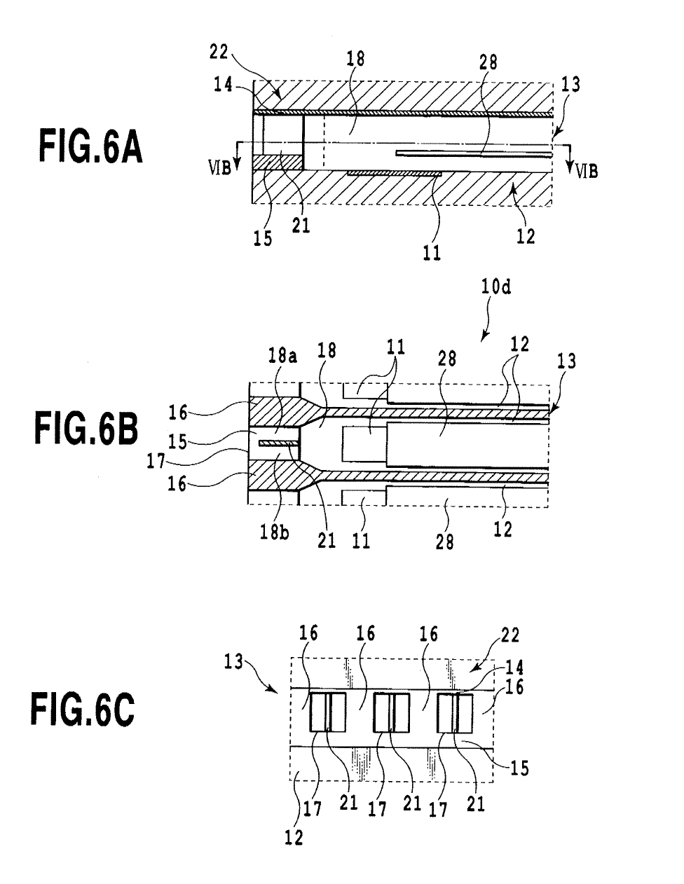

FIG. 6A is a longitudinally sectioned side view schematically showing a construction of a print head according to the third embodiment of this invention. FIG. 6B is a cross-sectional view taken along the line B-B of FIG. 6A. FIG. 6C is a front view of FIG. 6A.

The print head 10d in the third embodiment of this invention is also similar in the basic construction to the first embodiment. That is, on the heater board 12 having heaters 11 to heat ink and form bubbles for ejecting ink droplets, there is provided a nozzle forming member 13 that has nozzles formed therein, each comprising a nozzle opening 17 for ejecting ink and a liquid path 18 communicating with the nozzle opening. A top plate 22 is placed on the nozzle forming member 13.

The nozzle forming member 13 is also formed with a planar portion 14, sidewalls 16, a bottom portion 15 and dividing portions 21, all defining the nozzle openings. The dividing portions 21 are situated inward of each nozzle opening. In this third embodiment, a movable valve 28 is provided in each liquid path 18. This is the construction of the third embodiment that differs from the first embodiment. The free end of the movable valve 28 is disposed to face the heater 11 so that the movable valve 28 is displaced as a bubble is formed in ink upon energization of the heater 11.

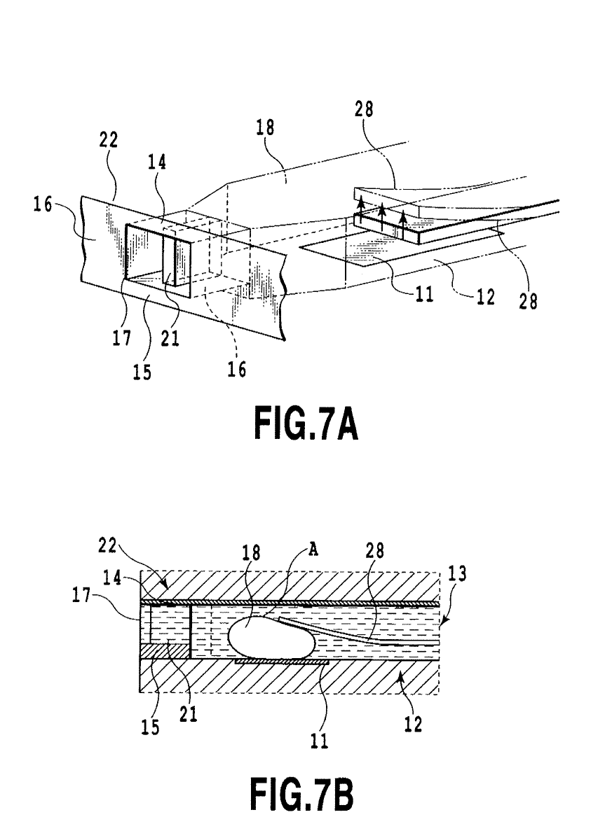

FIG. 7 is a perspective view schematically showing how the movable valve 28 is displaced as a bubble is formed in ink in the print head 10d of the third embodiment. As shown by a dashed line of FIG. 7A and in FIG. 7B, the free end of the movable valve 28 is displaced upward in the figures by the bubble formed in the ink. The movable valve 28 thus acts as a stopper that restricts the expansion of the bubble A toward the upstream (to the right in FIG. 7B), allowing the bubble to grow only toward the nozzle opening 17 side. As a result, the bubble forming energy can be utilized efficiently for the ink ejection, reducing power consumption and improving the ejection speed.

Further, the movable valve 28 of the third embodiment is effective in stabilizing the direction of ink ejection.

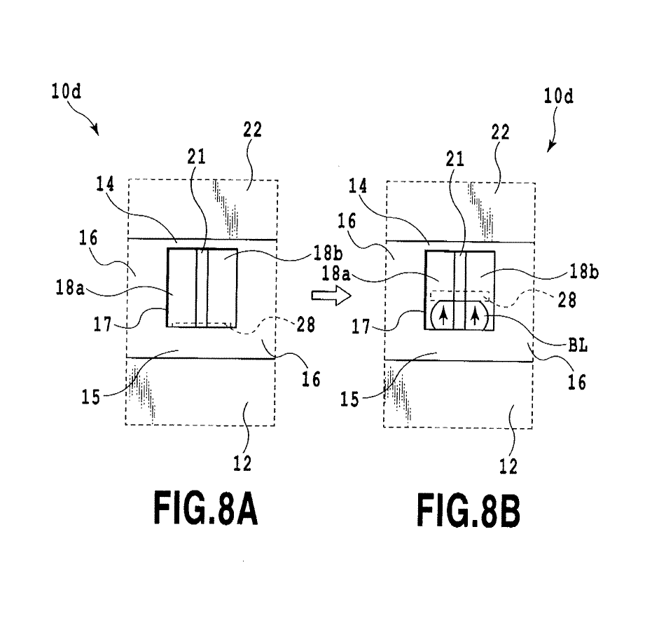

FIG. 8A and FIG. 8B are conceptual diagrams showing from the front how the movable valve 28 is displaced before and after a bubble is formed. FIG. 8A represents a state in which a bubble is yet to be formed in the ink. In this state, when a bubble is generated in ink by the heating action of the heater 21, the bubble 11 forces the movable valve 28 upward, with the end face of the valve shifting to a position where it divides the nozzle opening 17 into upper and lower portions, as shown in FIG. 8B. The dividing portion 21 is held at a position where it divides the nozzle opening 17 into left and right portions. So, the nozzle opening 17, when viewed from the front, is divided vertically and horizontally by the dividing portion 21 and the end face of the movable valve 28. Therefore, the ink forced by the bubble to flow through the liquid path 18 forms a laminar flow whose motion in the vertical and horizontal direction is restricted by the dividing portion 21 and the movable valve 28. This in turn stabilizes the direction of an ink droplet ejected from the nozzle opening.

In this third embodiment, the dividing portion may also be constructed to have tapers, as shown in FIG. 4 and FIG. 5.

### Other Embodiments

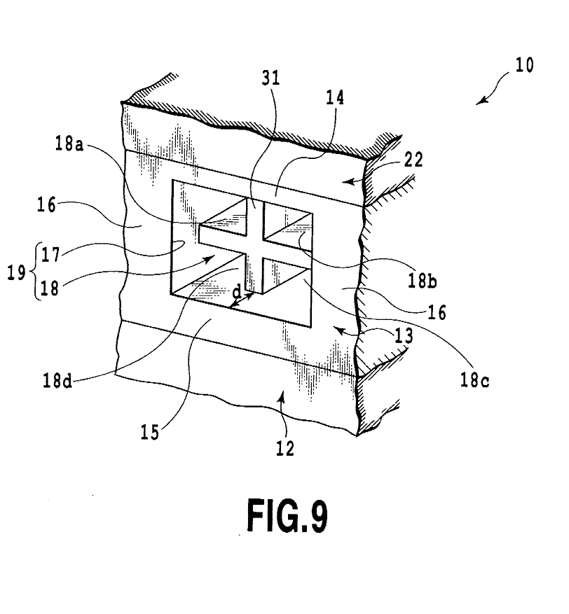

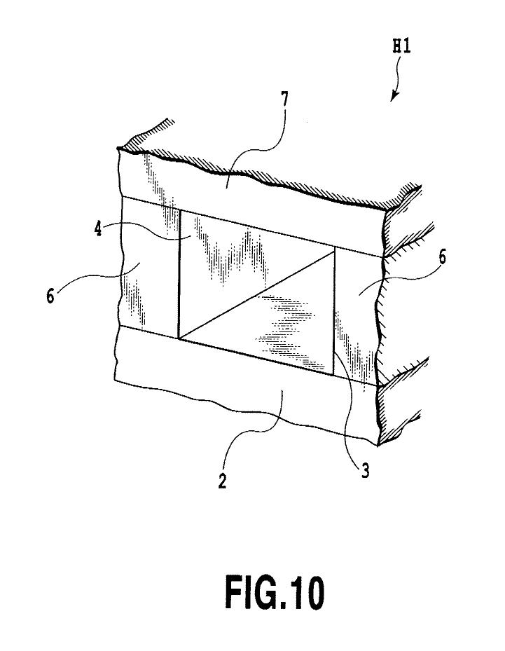

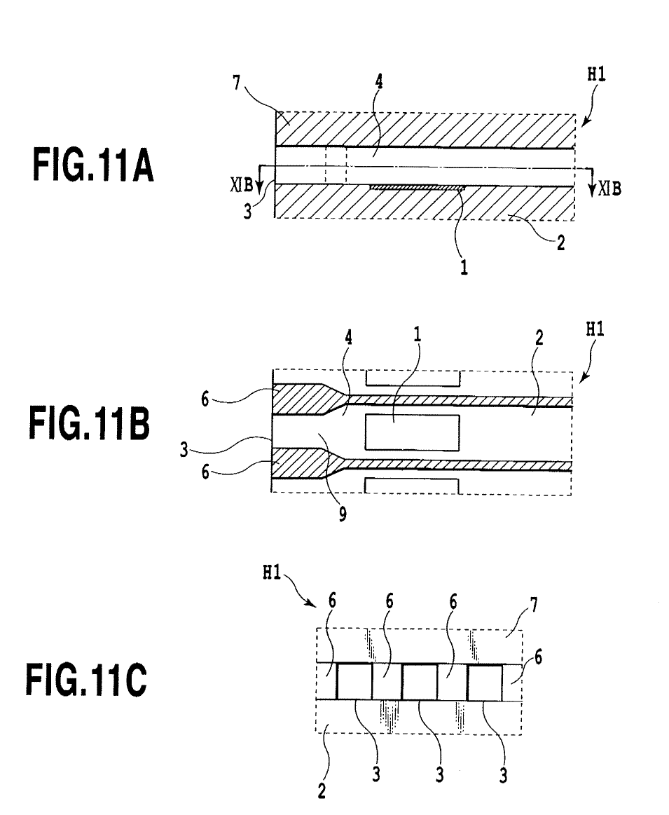

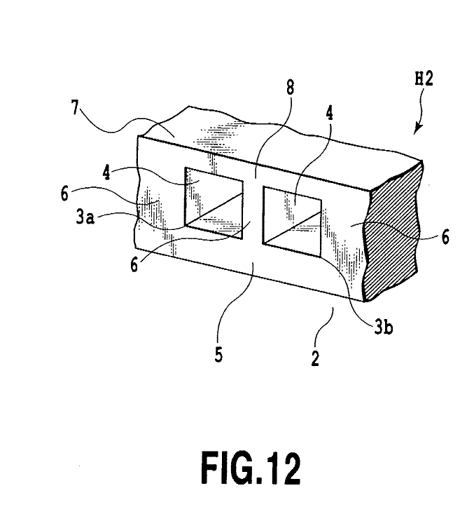

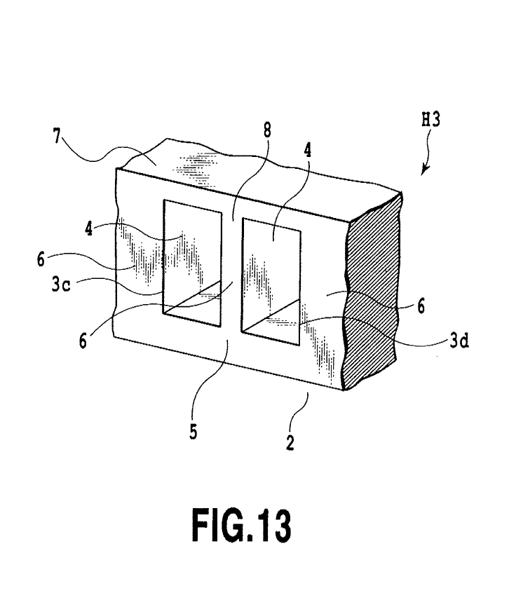

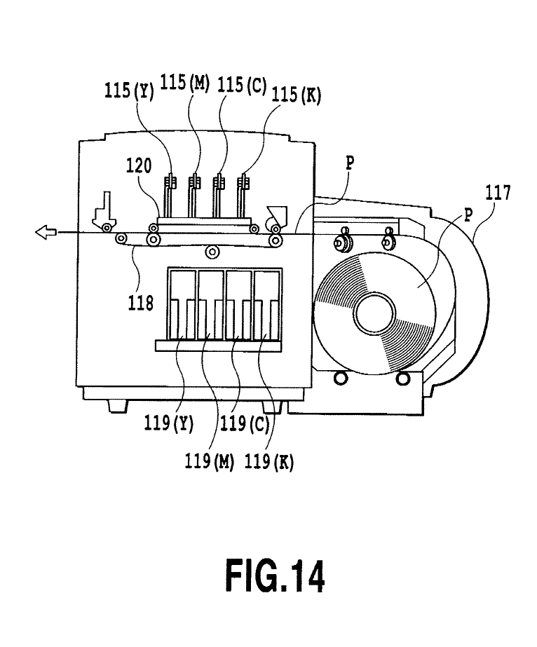

In the above embodiments a part of the liquid path is divided in two by one dividing portion installed inward of the nozzle opening. It is also possible to provide a dividing portion that divides the liquid path into three or more sections, thereby further enhancing a meniscus force in the path. For example, as shown in FIG. 9, a dividing portion 31 cross-shaped in cross section may be installed inward of the nozzle opening 17 to divide a part of the liquid path 18 into four paths 18a, 18b, 18c, 18d. With this construction, not only can the meniscus force in the liquid path 18 be increased but the direction of ejection of ink droplets can also be stabilized because the dividing portion 31 acts as a cross-shaped flow control element that stabilizes the laminar flow of ink as the ink is ejected.

It is noted that this invention is not limited to the above embodiments and that various modifications may be made within the spirit of this invention.

For example, in one printing apparatus ink may be supplied to one or more print heads. Further, the printing apparatus may be a full-line type that performs a printing operation without moving the print head, as described above, or a serial scan type that moves the print head in the main scan direction during the printing operation. The printing apparatus applicable to this invention is not confined to any particular printing system or type.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A print head comprising:
a plurality of nozzle openings to eject ink;
a plurality of liquid paths communicating with the nozzle openings; and
a plurality of energy generation means to generate an ejection energy for ejecting the ink supplied to each liquid path from each nozzle opening in the form of droplet;
wherein a dividing portion to divide a part of each liquid path into a plurality of paths is provided in an inward part of each liquid path.

2. A print head according to claim 1, wherein
the liquid paths are formed by a heater board, a nozzle forming member and a top plate facing the heater board, the heater board holding heaters to generate a thermal energy as the ejection energy, the nozzle forming member being disposed between the heater board and the top plate;
wherein the nozzle forming member has formed therein the plurality of nozzle openings and dividing portions and, in combination with the heater board, liquid paths.

3. A print head according to claim 1, wherein the dividing portion is formed of at least a flat plate provided in the liquid path.

4. A print head according to claim 3, wherein the dividing portion is formed in the liquid path between the nozzle opening and the heater.

5. A print head according to claim 3, wherein the dividing portion has a tapered portion that decreases in thickness toward the nozzle opening side.

6. A print head according to claim 3, wherein the dividing portion has a tapered portion that decreases in thickness toward the nozzle opening side and toward the heater side.

7. A print head according to claim 2, further including a movable valve that allows a bubble formed in the ink by heat from the heater to grow in the direction of ink ejection.
